(19) United States
(12) Patent Application Publication
(10) Pub. No.: US 2009/0104805 A1
(43) Pub. Date: Apr. 23, 2009

(54) Sealed Connector With Sequential Closure

(75) Inventors: Philippe Daudin, Pierres (FR); Sebastien Deubel, Longvilliers (FR)

Correspondence Address: HARRINGTON & SMITH, PC, 4 RESEARCH DRIVE, Suite 202, SHELTON, CT, 06484-6212, US

(73) Assignee: FCI, Versailles (FR)

(21) Appl. No.: 11/921,586

(22) PCT Filed: Jun. 9, 2005
(86) PCT No.: PCT/FR2005/001438

§ 371 Date: Oct. 17, 2008

(51) Int. Cl. H01R 13/52

(52) U.S. Cl. 439/274

(57) ABSTRACT

The invention concerns sealed electrical connectors of the type wherein sealing is obtained by compressing a seal using a mobile element. The invention also concerns an electrical connector including a housing, receiving at least one contact provided with a first termination for connection to a complementary contact and with a second termination connected to a cable, the housing including: a module for receiving the contact; a slide for compressing a sealing grommet on said cable, which can be moved between a retracted position for inserting the contacts and an advanced position for compressing the grommet; a front cover capable of being manipulated between an advanced position for preventing connection with a complementary connector and a retracted position allowing insertion of the complementary contacts. The slide is provided with a first system for preventing the front cover from being manipulated, this first system being removed when the slide is in the advanced position.

The present invention relates to sealed electrical connectors of the type where sealing is obtained by compressing a seal by means of a mobile element.

The invention is applied, in particular, in the field of automobile connectors wherein the connectors are wired in harnesses, and wherein the connector is sealed on the wire side by a seal through which pass several cables of variable diameter.

In this case, the seal must have, for passage of the cables, several sockets of sufficient size in order to permit passage of electrical contacts; and compression of the seal by the mobile element permits obtaining a tight seal even for cables of small diameter.

In connectors applied in the automobile, currently a contact locking device is provided that has an insertion position for insertion of the contacts and a contact locking position that assures that the contacts cannot be retracted when the connector housing is connected with a complementary connector housing having complementary contacts.

In order to do this, it is known to provide the contacts and the housings receiving them with complementary ratcheting means and to provide mobile means for closing the housings that can only be activated when all the contacts are correctly ratcheted in the connector housings.

Wiring the connectors thus consists sequentially of introducing the contacts into sockets in the housings for receiving them, then closing the housings.

Document U.S. Pat. No. 4,998,896 notably describes a connector housing of three parts, one front part for connecting with a complementary connector housing, an intermediate part for holding the contacts, and a rear part for holding a rear sealing grommet provided with means for ratcheting with a complementary connector housing.

The contacts are retained by spring latches, borne by the intermediate part, which ratchet into a groove provided in the contacts.

When a contact is not correctly ratcheted, the housing cannot be closed, since in this case, the free end of the corresponding latch butts up against a rear wall of the front part of the housing. Thus, coupling with a complementary connector housing is prevented when the contacts are poorly ratcheted.

A first problem with this device is that a significant force is necessary to push the contacts into the grommet.

Moreover, before the housing is completely closed, the contacts are only held between the latches, and this does not guarantee that they are held axially.

In fact, in such a connector, the nose or tip of the contacts passes through in between the latches and, if a contact is slightly off-center, it risks interfering with the rear walls of the socket of the front part that receives it, which may damage the latch or allow the latch to protrude and block the connector.

A second problem is that it is possible to lock the contacts while the grommet is not correctly applied against the wires and this is particularly true in the case of sealed connectors for automobile applications.

The object of the present invention is to guarantee a good rear seal of the wires in the connector housings, and, additionally, good ratcheting of the contacts, without possibility of forgetting an operation.

To do this, the present invention principally relates to an electrical connector having a housing, receiving at least one contact provided with a first termination for connecting with a complementary contact and a second termination connected to a cable, characterized in that the housing comprises:
a module for receiving the contact
a slide for compressing a sealing grommet on said wire, which [slide] can move between a retracted position for contact insertion and an advanced position for compression of the grommet,
a front cover that can be manipulated between an advanced position for preventing connection with a complementary connector and a retracted position allowing the complementary contacts to be inserted, the slide being provided with first means for preventing the manipulation of the front cover, with this means being removed when the slide is in the advanced position.

Thus, closing the front cover is only possible when the slide has first been manipulated from the retracted position to the advanced position to create the connector seal at the level of the outgoing cable.

More particularly, the connector slide according to the invention comprises at least one first means and one second means for preventing the manipulation of the front cover with sequential deactivation and activation.

According to this embodiment, not only does the first means for preventing manipulation prevent manipulating the front cover while the slide is not in position for compressing the grommet, but also, once the front cover is retracted, the second means blocks the front cover in said retracted position.

Other characteristics and advantages of the invention will be better understood upon reading the description that follows of a non-limiting example of embodiment of the invention accompanied by drawings that show:

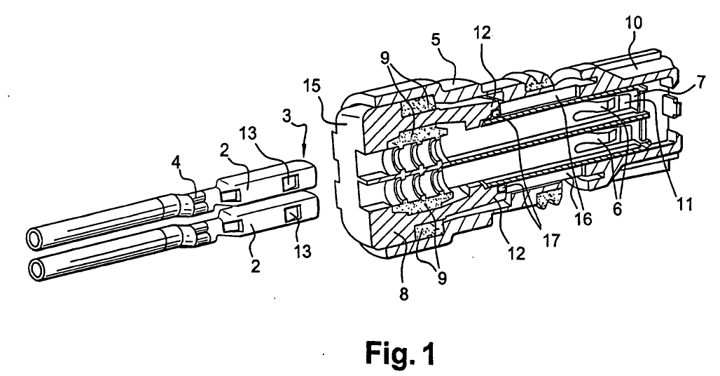

FIG. 1: a sectional perspective view of one example of embodiment of a connector according to the invention;

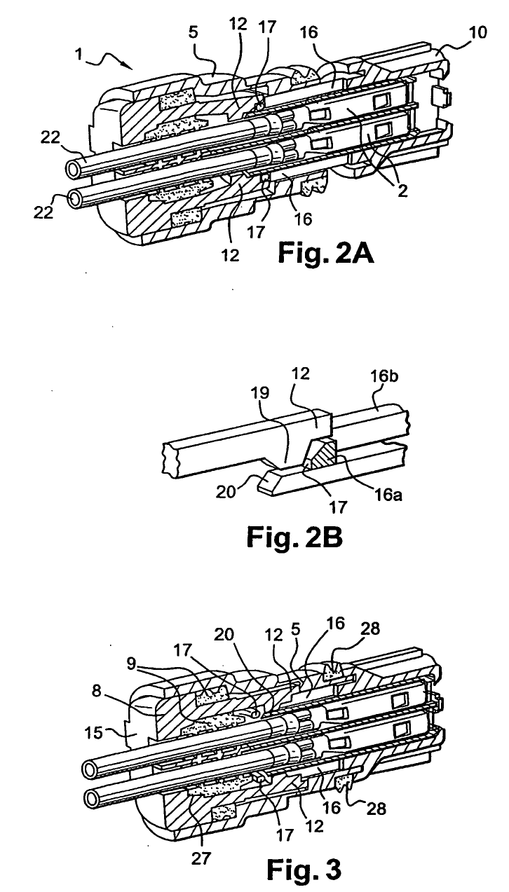

FIG. 2A: a sectional perspective view of the connector of FIG. 1 with the slide advanced into the position for unblocking the front cover;

FIG. 2B: a detail of FIG. 2A showing the position of the slide arm relative to the arm of the front cover;

FIG. 3: a sectional perspective view of the connector of FIG. 1 with the slide in the advanced position and the front cover in the retracted position;

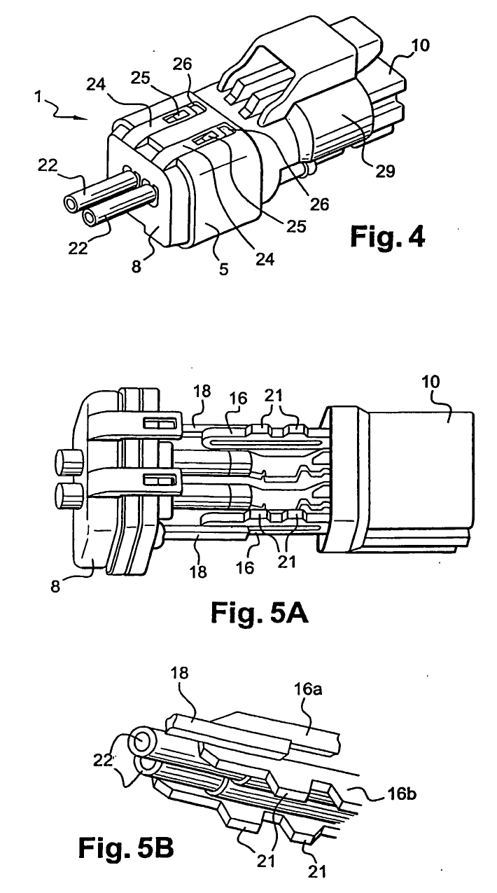

FIG. 4: an external perspective view of the connector of FIG. 1;

FIG. 5A: a perspective view of the slide, the front cover and the contacts in the position of FIG. 3;

FIG. 5B: a detail of FIG. 5A;

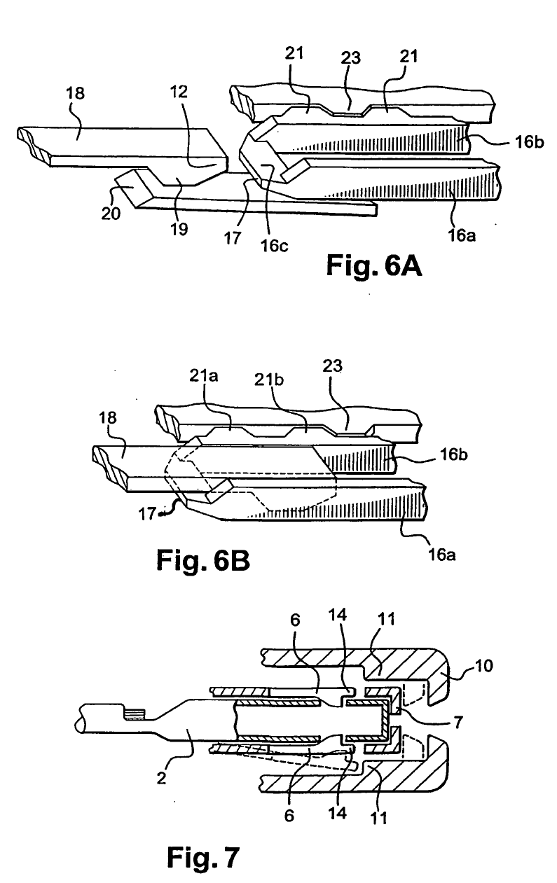

FIGS. 6A, 6B: a functional detail of the device with first and second means for preventing the manipulation of the front cover with sequential deactivation and activation;

FIG. 7: a schematic sectional view of the means for ratcheting and locking the connector contact of FIG. 1;

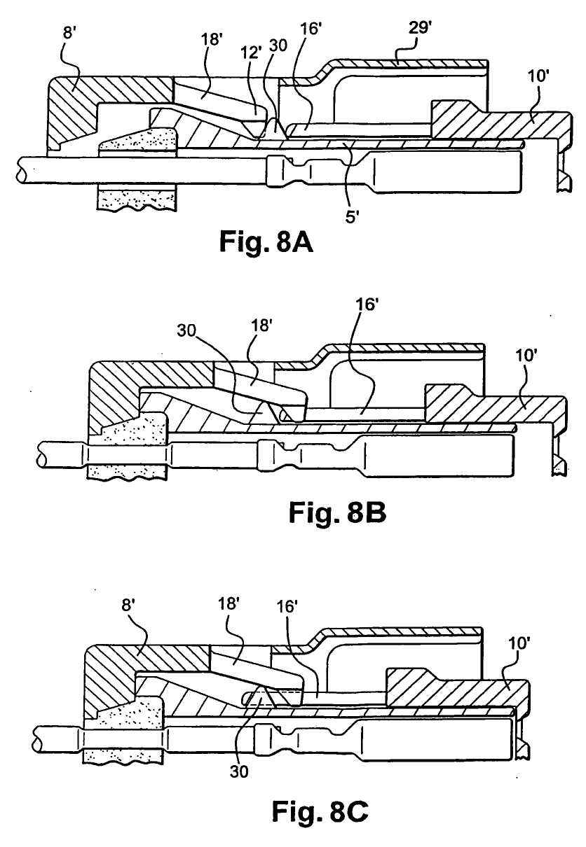

FIGS. 8A, 8B, 8C: side views of a variant of the invention.

The electrical connector according to the invention comprises a housing 1, shown particularly in exterior view in FIG. 4 and in sectional perspective view in FIG. 1 for a first variant of embodiment of the invention and, in FIGS. 8A to 8C, for a second variant.

According to the invention, the housing comprises a module 5 for receiving at least one contact 2, two contacts 2 according to the example shown, and has a front cover 10 designed to guide complementary contact terminals and possibly to provide an error-avoidance function when connecting connectors of the same type.

The connector according to the invention comprises a slide 8 for compressing a grommet 9 applied at the rear of the connector on wires 22 that exit from the connector.

In the variant of FIGS. 1 to 7, contact-bearing module 5 is the central part of the housing and comprises the outer envelope of the housing as well as a skirt 29 on the front of the housing, slide 8 being inserted into the contact-bearing module.

In the variant of FIGS. 8A to 8C, slide 8′ is extended toward the front of the connector to make up the outer body of the connector and a skirt 29′ around the front of the housing, contact-bearing module 5′ being in this case an inner piece with the connector which can move relative to the outer body of the connector.

More particularly, with regard to FIG. 1, module 5 is shown with contacts 2. These contacts are provided with a first termination 3 for connecting with a complementary contact and a second termination 4 connected to wires 22, by crimping or soldering in the known manner.

Contacts 2 are inserted through grommet 9 and, in order to prevent damage to the grommet, the contact passage openings are made large enough to minimize the deformation of this grommet, and can be made to accommodate contacts and wires of larger or smaller section as a function of the current to be carried.

As a result, once the contacts are inserted into the module, it is necessary to compress the grommet firmly on the cables to flatten the lips made in the cable passage openings.

Slide 8 functions to carry out this compression and in order to do this, can be manipulated from a retracted position for contact insertion, the position visible in FIG. 4, to an advanced position (i.e., in the direction of the coupling face for the module corresponding to connection terminations 3 of the contacts) for compression of the grommet.

In order to compress the grommet, slide 8 has a rear wall 15 drilled with axial holes for passage of the contact or contacts, which, in the advanced position of the slide, compress[es] the grommet on the cable or cables. This wall also comprises enlarged areas 27 on its periphery to press the grommet against the cables.

In order to define these two positions, according to the example, the slide has outer arms 24 provided with slots ratcheting with spurs 25 in the retracted position and 26 in the advanced position.

According to the invention, module 5 for receiving contact 2 is also provided with means 6 for ratcheting the contact, having latches positioned in a wall of the opening for receiving socket 2, this wall making up part of a contact guiding sheath 7 extending downstream of ratcheting means 6.

The latches forming ratcheting means 6 are, according to the example, received and ratcheted in slots 13 made in the lateral walls of contacts 2.

Front cover 10 is provided with contact locking means 11, the contact locking means borne by the front cover comprising a wall 11 for blocking ratcheting means 6.

In order to lock the contacts, the front cover can be manipulated between an advanced position for releasing the contacts and a retracted position for locking the contacts.

The contact locking function is shown in FIG. 7; the free contact position is indicated by the solid lines and the locked position by the dashed lines.

The contacts are locked when the front cover is in a retracted position, for which walls 11 of the front cover rest on the latches so as to keep them from being pushed aside when the contacts are pulled toward the rear (cable side) of the connector.

In contrast, when the front cover is in the advanced position, the latches can be pushed aside into the recesses arranged behind wall 11, which permits, on one hand, inserting the contacts into the sockets and, on the other hand, releasing the contacts when they are pulled on.

According to the invention, slide 8 for compressing grommet 9 on wire 22, which can be moved between a retracted position for contact insertion and an advanced position for compression of grommet 9, is provided with first means 12 for preventing the manipulation of front cover 10, these means being removed when slide 8 is in the advanced position.

Additional security is obtained at the level of means 6 for ratcheting the contacts 2 due to the fact that this means has a removable stop means 14 forming, when the contact is poorly ratcheted, a second means for preventing the manipulation of the front cover by coming to rest against a wall 11 of the front cover as shown in the dotted lines of FIG. 7.

These means are created to define a precise closing sequence for the connector to assure that the slide has been properly pushed to the front and to guarantee the rear sealing of the connector before locking the contacts and retracting the front cover, thus permitting the coupling of the connector of the invention with a complementary connector.

Thus, the front cover can only be manipulated into the retracted position when both conditions are fulfilled: slide advanced and contacts correctly ratcheted.

The position of retracted front cover/advanced slide is shown in FIG. 3 where the blocking of a front peripheral seal joint 28 by a rear edge of the front cover is also shown.

Particularly with reference to FIGS. 2A and 2B, the first means for preventing manipulation of the front cover, borne by the slide, comprise first arms 18 directed towards the front of the housing and provided with a frontal stop 12 that is positioned, when the slide is retracted, so that it interferes with a distal end 17 of second arms 16 borne by the front cover and directed towards the rear of the housing.

Arms 18 are flexible spring arms whose terminations 12 are close to one another when the arms are not resting against ramp 20. The interference position is the position of FIG. 1 for which the front stops 12 on the free end of the arms abut against end 17 of the second arms when retracting of the front cover is attempted.

In order to activate the front cover, it is necessary to move the arms out of the interference position.

To do this, module 5 has ramps 20, shown in particular in the detail of FIG. 2B, on which the arms will slide when the slide is moved to the advanced position. First arms 18 are provided with a digit 19 that cooperates, during the passage of the slide from the retracted position to the advanced position, with ramp 20 of the module, to move aside front stop 12 from its position of interfering with said distal end 17.

In this position, when one presses on the front cover, arms 18 borne by slide 8 can pass above distal end 17 of the arm borne by the front cover due to fact that said end 17 and said digit 19 have a slope.

Second arms 16 are more particularly shown in FIGS. 6A and 6B and are made up of a U-shaped piece bearing axial legs 16a, 16b connected by a cross piece 16c.

Thus, when slide 8 is in the advanced position with digit 19 positioned on ramp 20, during the passage of the front cover from its advanced position to its retracted position, digit 19 passes above cross piece 16c and is lodged between axial legs 16a, 16b, which permits, as will be seen below, creating a second means for preventing the manipulation of the front cover, this time activated in order to prevent unblocking the front cover once it is in the retracted position.

The front cover is provided with means for ratcheting on the module in the advanced position and in the retracted position.

These means shown in FIGS. 6A and 6B are created on at least one of second arms 16 which, according to this example, is provided with spring means made up of leg 16b, which is flexible along its length, axial leg 16b being also connected to leg 16a by cross piece 16c.

Spring leg 16b is provided with indentation means 21 defining, with a complementary indentation means 23 for the module, said retracted and advanced positions of the front cover by ratcheting indentation means 23 between teeth 21a, 21b of means 21 in the advanced position for insertion/extraction of the contacts in FIG. 6A and abutting against first tooth 21b in the retracted position of FIG. 6B.

When the front cover is pushed into the retracted position, due to the fact that the end of arm 18 borne by the slide is itself in the advanced position, this end passes above cross piece 16c and is found positioned between axial legs 16a, 16b.

According to one advantageous embodiment of the invention, arm 18 is dimensioned so as to block the spring means and indentation means 21, 23, so as to hold the front cover in the retracted position.

Thus, it is no longer possible to return the front cover to the advanced position for unlocking the contacts if the slide has not been returned to the rear position for decompression of grommet 9.

The connector has at least one first and one second means 12, 18 for preventing the manipulation of the cover with sequential deactivation and activation made by means of the slide so that only one sequence of engagement and closing of the connector is possible, this sequence starting from a position where the slide is in the retracted position and the front cover is in the advanced position, beginning by introducing the contacts into the sockets through grommet 9, pushing slide 8 towards the front of the connector to compress the grommet, then pushing the front cover towards the rear of the connector to lock the contacts.

Likewise, to disconnect the connector, the only possible sequence is to retract the slide to release the front cover, then to pull the front cover towards the front in order to release the contacts, and finally to remove the contacts through the grommet by overcoming the force ratcheting latches 6 in slots 13 of the contacts.

The variant of FIGS. 8A to 8C differs from the example described above in that slide 8′ makes up part of an outer body provided with a skirt 29′ surrounding the front part for coupling with a complementary connector.

According to this variant, the contact-bearing module is received in the slide and slide 8′ bears an arm 18′ provided with a stop 12′ interfering with an arm 16′ of a front cover 10′, and thus is opposed to the retraction of cover 10′ when arm 18′ is behind a ramp 30.

The connector is closed according to this variant by pushing slide 8′ and front cover 10′.

Pushing the slide to the side first permits arm 18′ to pass over ramp 30 to come into the position of FIG. 8B.

In this position, stop 12′ no longer interferes with the end of arm 16′ of front cover 10′, arm 16′ can thus move and takes the position in FIG. 8C for which the end of arm 16′ is positioned behind ramp 30.

The invention is not limited to the example shown and in particular can be equally applied to connectors receiving female or male contacts.

1. An electrical connector comprising a housing, receiving at least one contact provided for a first termination for connecting with a complementary contact and a second termination connected to a wire, characterized in that the housing comprises:
a module for receiving contact
a slide for compressing a sealing grommet on said wire, which can move between a retracted position for insertion of the contacts and an advanced position for compressing grommet,
a front cover that can be manipulated between an advanced position for preventing the connection with a complementary connector and a retracted position allowing complementary contacts to be inserted,
slide being provided with first means for preventing the manipulation of front cover, this means then being removed when slide is in the advanced position.

2. The electrical connector according to claim 1, further characterized in that said ratcheting means comprise a latch ratcheted in a slot of contact.

3. The electrical connector according to claim 1, further characterized in that the contact locking means borne by the front cover comprise a wall for blocking ratcheting means.

4. The electrical connector according to claim 1, further characterized in that ratcheting means bear a removable stop means forming, when the contact is poorly ratcheted, a second means for preventing manipulation of the front cover.

5. The electrical connector according to claim 1, further characterized in that slide bears a rear wall drilled with axial holes for passage of the contact or contacts that, when the slide is in the advanced position, compress the grommet on the cable or cables.

6. The electrical connector according to claim 1, further characterized in that the first means for preventing the manipulation of the front cover, borne by the slide, comprise first arms directed towards the front of the housing and provided with a front stop positioned, when the slide is retracted, so as to interfere with a distal end of second arms borne by the front cover and directed towards the rear of the housing.

7. The electrical connector according to claim 6, further characterized in that first arms are provided with a digit, cooperating with a ramp of the module when the slide moves from the retracted position to the advanced position, in order to remove front stop from its position of interference with distal end.

8. The electrical connector according to claim 6, further characterized in that second arms are made up of U-shaped pieces with axial legs connected by a cross piece.

9. The electrical connector according to claim 8, further characterized in that, if slide is in the advanced position when the front cover goes from its advanced position to its retracted position, digit passes over cross piece and is inserted between axial legs.

10. The electrical connector according to claim 8, further characterized in that at least one of second arms is provided with spring means and indentation means defining, with complementary indentation means of the module, said retracted and advanced positions of the front cover.

11. The electrical connector according to claim 9, further characterized in that, when the front cover is in the retracted position and the slide is in the advanced position, arm blocks spring means and indentation means so as to hold the front cover in the retracted position.

12. The electrical connector according to claim 1, further characterized in that the slide has at least one first means and one second means for preventing manipulation of the front cover with sequential deactivation and activation.
